(19) United States
(12) Patent Application Publication
(10) Pub. No.: US 2003/0140746 A1
(43) Pub. Date: Jul. 31, 2003

(54) Package opening cutter

(76) Inventor: Jyuro Yamagishi, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/353,972

(22) Filed: Jan. 30, 2003

(30) Foreign Application Priority Data
Jan. 31, 2002 (JP) 2002-22924

(51) Int. Cl. B26D 7/01

(52) U.S. Cl. 83/13; 83/437.1

(57) ABSTRACT

A package opening cutter is provided which can accurately, safely and efficiently open the package without damaging the merchandise inside and in which the cutter will not come out during use. It comprises an angle ruler, retaining portions provided at both sides of the angle ruler, a clamp body provided so as to be pushed into and pulled out of the retaining portion for clamping a cutter, and means for preventing the clamp body from coming out of the retaining portion. The means for preventing the clamp body from coming out has a bolt slidably provided between the cutter retaining portion and the cutter clamp body. The bolt is operated by a knob provided on outer surface of the cutter retaining portion.

### BACKGROUND OF THE INVENTION

This invention relates to a package opening cutter used to open a carton, particularly a package in which a plurality of pieces of merchandize are packaged.

Generally, a plurality of pieces of merchandise are packaged in a carton and sorted in a distribution stage according to order amounts by opening the carton and dispatched. At a retail store, the carton is opened and the merchandise is taken out and displayed.

At large stores, to save manpower, a business method is sometimes adopted in which instead of displaying all the goods, cartons are stacked with their top open to give people an impression that they are sold at low prices.

For such purpose, tops of cartons are frequently cut and opened. If the top of a carton 81 is opened with an ordinary cutter as in FIG. 11, there is a fear that the cutter may damage the merchandise S inside. Also a worker may get injured due to slip of his hand. Further, it is difficult to cleanly cut and open packages.

The applicant has proposed a tool which makes it possible to accurately (in JP patent publication 2001-322615).

The cutter makes it possible to accurately cut along corners of a carton without damaging the merchandise inside while ensuring safety of work and to improve work efficiency.

But when the package opening cutter is used repeatedly, due to a thrust acting on the cutting edge, a cutter clamping body (hereinafter simply referred to as a clamp body) tends to come out of a cutter retaining portion (hereinafter simply referred to as a retaining portion.

An object of this invention is to provide a package opening cutter in which the cutter will never come out of the retaining portion together with the clamp body even after repeated use without impairing advantages of the package opening cutter.

### SUMMARY OF THE INVENTION

According to this invention, there is provided a package opening cutter comprising an angle ruler, retaining portions provided at both sides of the angle ruler, a clamp body provided so as to be pushed into and pulled out of the retaining portion for clamping a cutter, and means for preventing the clamp body from coming out of the retaining portion.

According to this invention, it is possible to accurately, safely and efficiently open a package along corners of a carton without damaging the merchandise inside and without the fear of getting a cut and also prevent the cutter from coming out together with the clamp body.

### BRIEF DESCRIPTION OF THE DRAWINGS

Other features and objects of the present invention will become apparent from the following description made with reference to the accompanying drawings, in which:

FIG. 1A is a partially cutaway front view of the package opening cutter according to this invention;

FIG. 1B is a perspective view thereof with the cutter box opened;

FIG. 2A is a perspective view of the clamp body;

FIG. 2B is a plan view thereof with its hinge opened;

FIG. 3A is an explanatory view showing how the clamp body is mounted;

FIG. 3B is a sectional view of the clamp body mounted;

FIG. 4 is a perspective view of the package opening cutter;

FIG. 5 is a side view of the same;

FIG. 6 is a perspective view as seen from the back of the same;

FIG. 7 is an explanatory view showing how it is used;

FIGS. 8A and 8B are views of the means for preventing the clamp body from coming out;

FIG. 9A is a plan view of the fall-preventive means;

FIG. 9B is a front view of the same;

FIG. 9C is a back view of the same;

FIG. 9D is a right side view of the same;

FIG. 10 is a perspective view of a carton after opened; and

FIG. 11 is a view showing how a carton is opened with an ordinary cutter.

### DETAILED DESCRIPTION OF THE PREFERRED EMBODIMENT

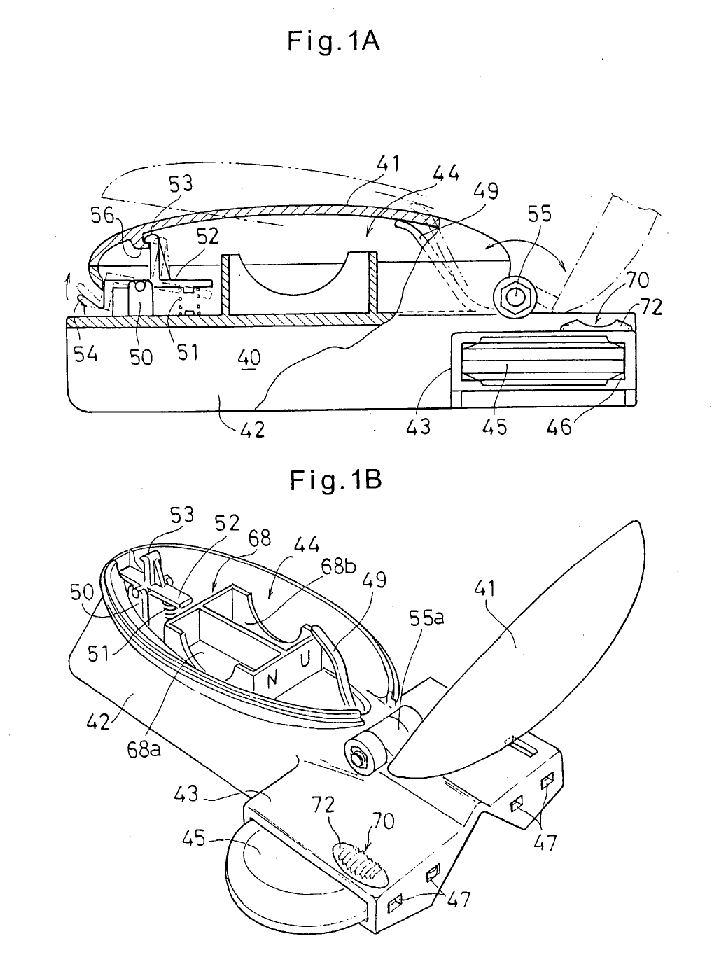

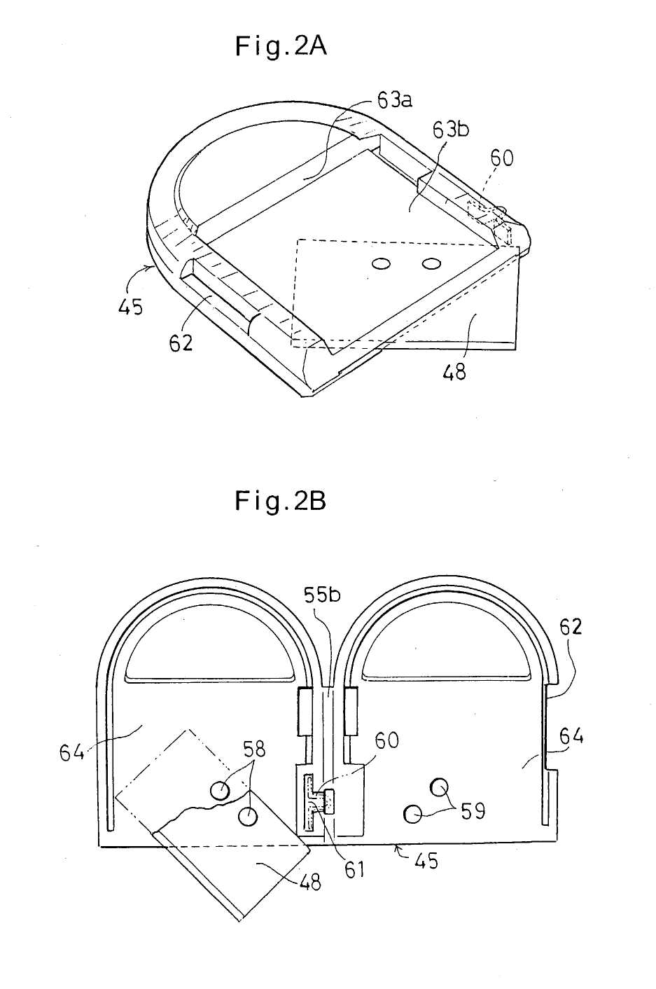

An embodiment of this invention will be described with reference to the drawings. As shown in FIG. 1, the package opening cutter comprises an angle ruler 42, retaining portions 43, a cutter box 44, a clamp body 45 and a fall-preventive means 70, all formed by molding a plastic. The retaining portions 43 are integrally provided at one end of the angle ruler 42 at both sides thereof. The retaining portions 43 each have a through hole 46 for receiving the clamp body 45. In the through hole 46, notches 47 are formed to adjust the cutting edge of a cutter 48 (FIG. 2A) sandwiched in the clamp body 45.

The cutter box 44 has housing spaces 68a and 68b for cutters 48 (68a is a space for housing brand-new cutters; 68b is a space for housing used cutters), a spring piece 49, a bearing 50, a balance 52 supported on the bearing 50 and biased by a spring 51, a hook 53 integral with the balance 52, and a tab 54 integral with the balance 52 and protruding out of the cutter box 44.

To the cutter box 44, a lid 41 is pivotally mounted by a hinge 55a and kept biased in an opening direction by the spring piece 49. The hook 53 is adapted to engage a claw 56 formed on the inner surface of the lid 41 (FIG. 1A).

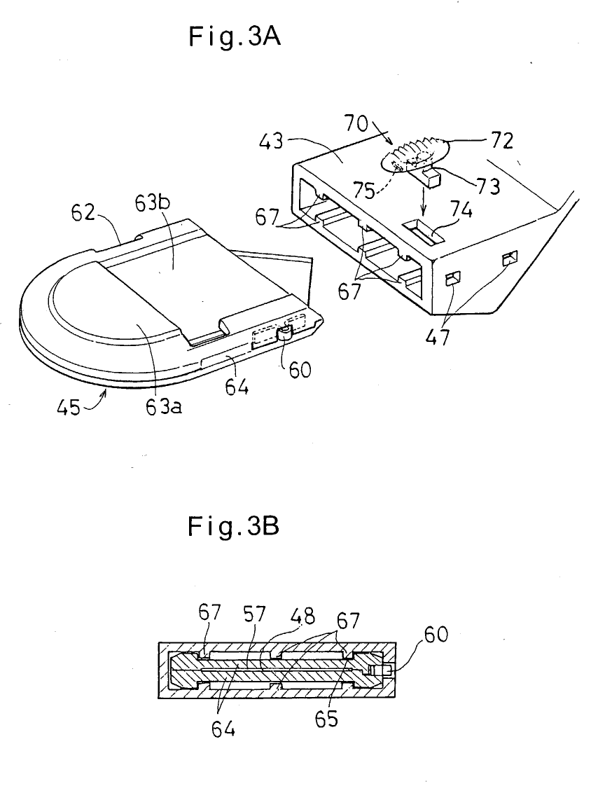

As shown in FIG. 2A, the clamp body 45, which clamps the cutter 48, is formed by injection-molding a plastic, and has a recess 57 (FIG. 3B) for receiving the cutter 48, two protrusions 58 for positioning the cutter 48, holes 59 for receiving the protrusions 58, a recess 61 for receiving a Ω-shaped spring 60, and a cutout 62 for opening the clamp body 45. At its portion where the cutter 48 is not sandwiched, a step 63a having a large wall thickness is formed, while at its portion where the cutter 48 is sandwiched, a recess 63b is formed. Two plates 64 are formed and connected together by a hinge 55b (FIG. 2B).

When the cutter 48 is fitted in the recess 57 and on the protrusions 58 with the Ω-shaped spring 60 received in the recess 61 and the plates 64 folded, it becomes the state of FIG. 2A. In this state, as seen in FIG. 3B, the opposed surfaces of the plates 64 face and fit each other with the Ω-shaped spring 60 slightly protruding outward.

The clamp body 45, which is clamping the cutter 48, is fitted in one of the two retaining portions 43 (FIG. 3A). At this time, the recess 63b engage ribs 67 formed in the retaining portion 43 to prevent lateral shaking. The Ω-shaped spring 60 fit in a notch 47 so that the cutting edge can be adjusted in one of two positions, i.e. in the package opening state and the retracted state. The retaining portions 43 are provided on both wings of the angle ruler 42 so that a user can use it irrespective of whether he or she is a right-hander or left-hander.

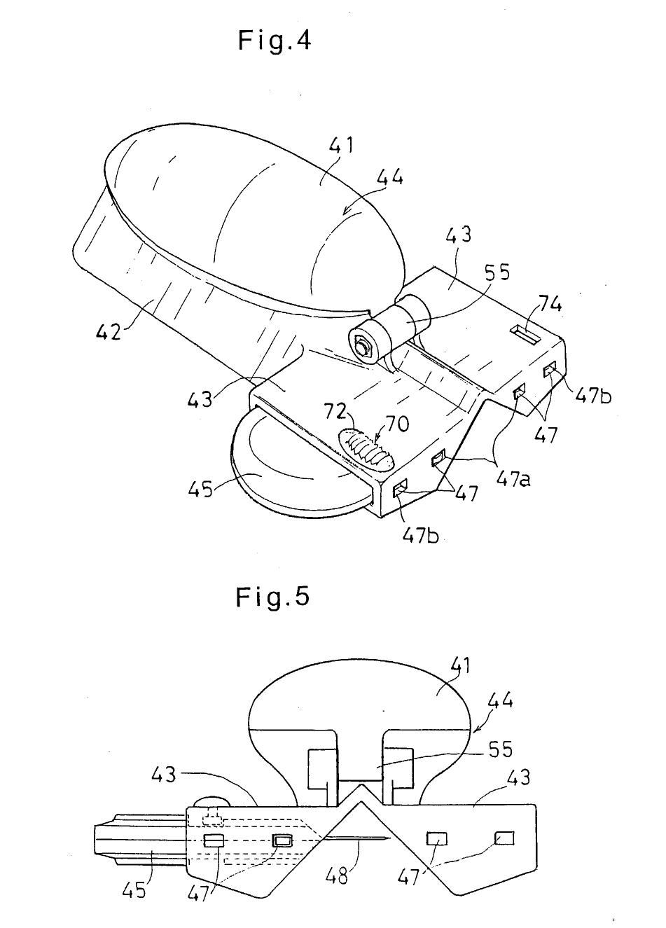

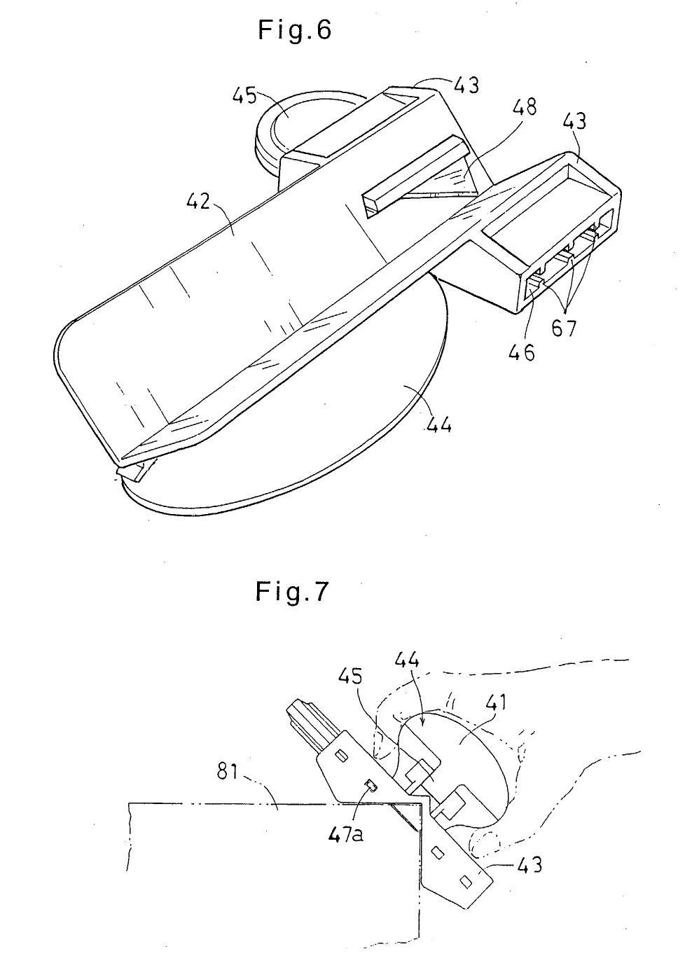

FIGS. 4 to 6 show how the cutter 48 is mounted in one of the retaining portions 43 through the clamp body 45 and is used. FIG. 7 shows how a package is cut with the Ω-shaped spring 60 fitting in the notch 47a. Now the cutter 48 protrudes markedly to cut and open the top of a carton 81. When the package opening work ends, the Ω-shaped spring 60 is fitted in the notch 47b where the cutter 48 is retracted to a safe state.

When the cutter 48 is worn, the plates 64 of the clamp body 45 are opened, and the cutter 48 is turned over, fitted on the protrusions 58, and fitted in one of the retaining portions 43 and used. When it is further worn, it is replaced with a new cutter in the cutter box 44.

Since the cutter 48, which is fitted in one of the two retaining portions 43 in the clamp body 45, is inclined relative to the angle ruler 42, there is a possibility that a thrust in the pull-out direction acts and the cutter 48 retracts together with the clamp body 45. Thus, as a fall-preventive means 70 for the clamp body 45, as in FIGS. 3-5 and 8, between the retaining portions 43 and the clamp body 45, a bolt 71 is slidably provided. The bolt 71 is operated with a knob 72 provided on the outer surface of one of the retaining portions 43. (This fall-preventive means 70 can be mounted on either one of the retaining portions 43 on both wings of the angle ruler 42.

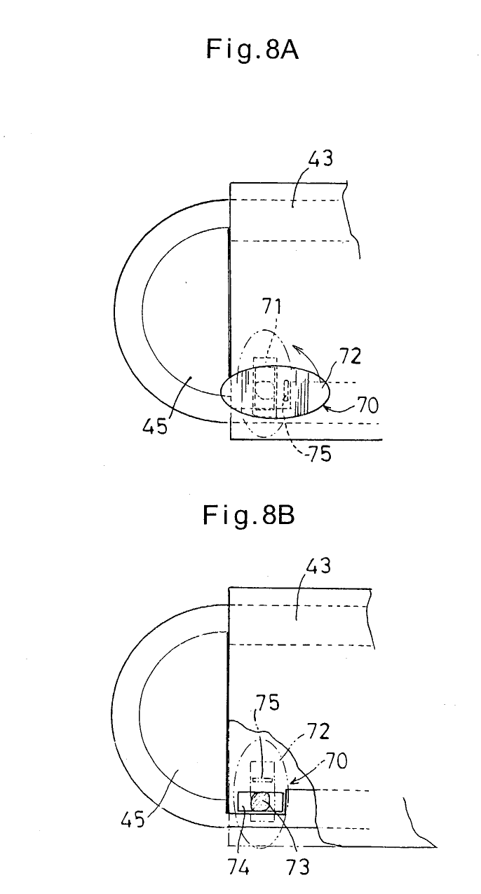

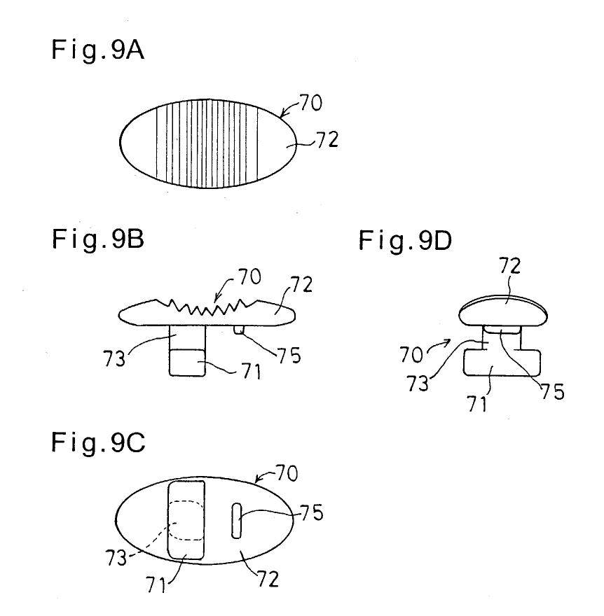

The bolt 71 and the knob 72 are integrally connected together by a square shaft 73. As for fitting in the retaining portion 43, when the bolt 71 is fitted in a square hole 74 as in FIGS. 3A and 8A and turned 90°, it becomes a state as shown in FIGS. 1B, 4A and 8B. When the knob 72 is slid, the bolt 71 also slides, and gets engaged between the retaining portion 43 and the clamp body 45 to form the fall-preventive means 70.

When the bolt 71 and the knob 72, which are integrally connected together by the square shaft 73, are fitted in one of the retaining portions 43, they may run out in one of the rotational directions. A fall-preventive protrusion 75 is provided which slightly protrudes from the back of the knob 72. It fits in the opening of the square hole 74 to prevent runout of the fall-preventive means 70. Since the protrusion 75 protrudes only slightly, when the bolt 71 is inserted and turned 90°, the knob 72 will deform and make turning possible.

Instead of the bolt, a pin hole may be formed between the clamp body and each retaining portion and a pin may be inserted in the pin hole.

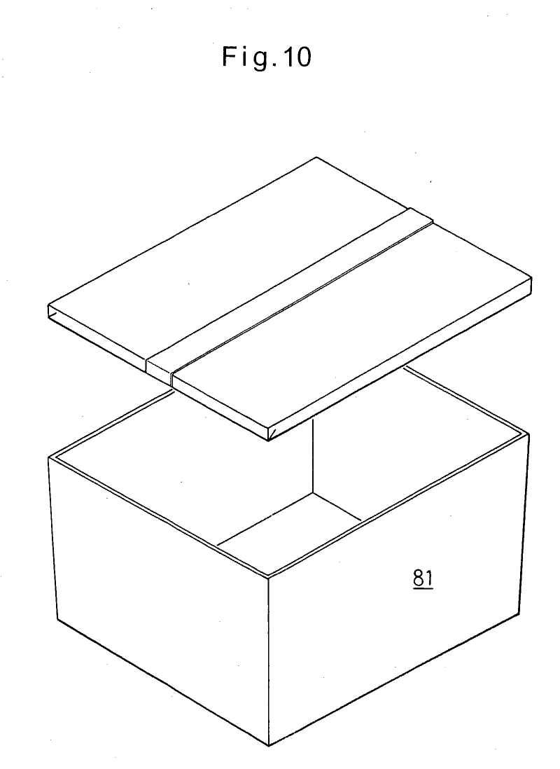

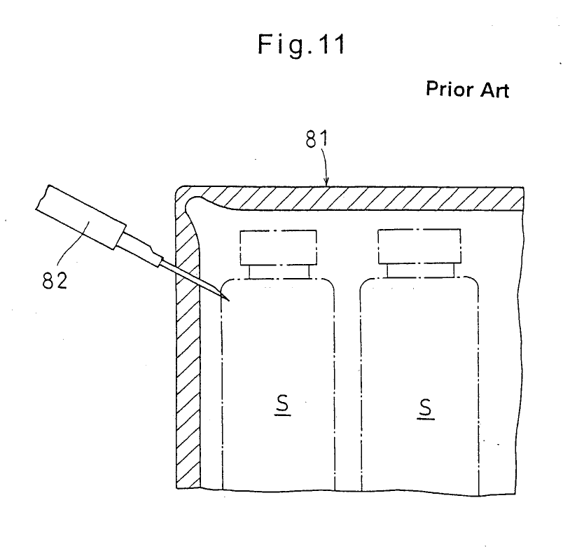

FIG. 10 shows how the carton is cut and opened with the package opening cutter according to this invention. It is cut cleanly along the top corners.

The package opening cutter is formed by injection-molding a plastic. But it may be formed by die casting of aluminum or its alloy.

As described above, according to this invention, merely by sliding the angle ruler with the cutter along ridges of a carton, it can be opened safely, reliably and quickly by forming a cut without damaging the merchandise inside. Even if it is repeatedly used, there is no worry of the cutter fitted in one of the retaining portions coming off.

What is claimed is:

1. A package opening cutter comprising an angle ruler, retaining portions provided at both sides of said angle ruler, a clamp body provided so as to be pushed into and pulled out of said retaining portion for clamping a cutter, and means for preventing said clamp body from coming out of said retaining portion.

2. A package opening cutter as claimed in claim 1 wherein said means for preventing said clamp body from coming out comprises a bolt slidably provided between said retaining portion and said clamp body, said bolt being operated with a knob provided on outer surface of said retaining portion.

3. A package opening cutter as claimed in claim 1 or 2 wherein said knob is provided with a protrusion for preventing said knob from running out.

4. A package opening cutter as claimed in claim 1 wherein said means for preventing said clamp body from coming out comprises a pin which can be inserted into and pulled out of between said retaining portion and said clamp body.
